(19) United States
(12) Patent Application Publication
(10) Pub. No.: US 2023/0033828 A1
(43) Pub. Date: Feb. 2, 2023

(54) INFORMATION PROCESSING DEVICE, INFORMATION PROCESSING METHOD, AND PROGRAM

(71) Applicant: SONY GROUP CORPORATION, TOKYO (JP)

(72) Inventors: KEITARO MACHIDA, TOKYO (JP); TOMOMITSU HERAI, TOKYO (JP); HIROKI MORIYA, TOKYO (JP); MASARU SHIRASUNA, TOKYO (JP); ITARU SHIMIZU, TOKYO (JP); SUGURU AOKI, TOKYO (JP); KAZUHITO IWASA, TOKYO (JP); YOSHIYUKI KOBAYASHI, TOKYO (JP); KENTA KAWAMOTO, TOKYO (JP)

(21) Appl. No.: 17/789,715

(22) PCT Filed: Dec. 25, 2020
(86) PCT No.: PCT/JP2020/048722

§ 371 Date: Jun. 28, 2022

(30) Foreign Application Priority Data
Jan. 8, 2020 (JP) 2020-001590

(51) Int. Cl. G06N 20/00

(52) U.S. Cl. CPC G06N 20/00

(57) ABSTRACT

The present technology relates to an information processing device, an information processing method, and a program capable of outputting a behavior in consideration of benefits or moral codes of other systems.

A first evaluation unit configured to evaluate a behavior from a self-viewpoint, a second evaluation unit configured to evaluate the behavior from another's viewpoint, and a determination unit configured to determine whether the behavior is performed from a first evaluation result in the first evaluation unit and a second evaluation result in the second evaluation unit are included. A third evaluation unit configured to evaluate the behavior from an objective viewpoint is further included. The determination unit performs the determination using a third evaluation result in the third evaluation. The present technology may be applied to an information processing device that determines a self-behavior in consideration of benefits or moral codes of other systems.

### TECHNICAL FIELD

The present technology relates to an information processing device, an information processing method, and a program and to, for example, an information processing device, an information processing method, and a program capable of performing evaluation in consideration of a benefit of another system.

### BACKGROUND ART

Machine learning in which maximizing remunerations obtained from the environment is a goal and a control method for achieving the goal is learned by trial-and-error is also referred to as reinforced learning in a broad sense. PTL 1 proposes a learning method in which learning is efficiently performed even in an environment in which a probability of arriving at a state in which remunerations are obtained is low.

### CITATION LIST

### Patent Literature

### [PTL 1]

JP 2018-198012A

### SUMMARY

### Technical Problem

Reinforced learning is learning in which maximizing a benefit of a system in a certain environment (agent; behavior entity) is a goal. However, when an individual system behaves to maximize a benefit of the individual system in an environment in which a plurality of systems are mixed, one system interferes with behaviors of the other systems. As a result, the behavior is likely to be a behavior in which none of the systems can obtain a maximum benefit.

A behavior equivalent to a self-benefit is also likely to be a behavior which is not suitable for moral codes.

A system that operates in cooperation with other systems or a system that behaves in consideration of moral codes is preferable.

The present technology has been devised in such circumstances and enables a system to operate in cooperation with other systems or behave in consideration of moral codes.

### Solution to Problem

An information processing device according to an aspect of the present technology is an information processing device including: a first evaluation unit configured to evaluate a behavior from a self-viewpoint; a second evaluation unit configured to evaluate the behavior from another's viewpoint; and a determination unit configured to determine whether the behavior is performed from a first evaluation result in the first evaluation unit and a second evaluation result in the second evaluation unit.

An information processing method according to another aspect of the present technology is an information processing method of causing an information processing device to perform: evaluating a behavior from a self-viewpoint; evaluating the behavior from another's viewpoint; and determining whether the behavior is performed from an evaluation result of the behavior from the self-viewpoint and an evaluation result of the behavior from the other's viewpoint.

A program according to still another aspect of the present technology is a program causing a computer to perform: evaluating a behavior from a self-viewpoint; evaluating the behavior from another's viewpoint; and determining whether the behavior is performed from an evaluation result of the behavior from the self-viewpoint and an evaluation result of the behavior from the other's viewpoint.

In the information processing device, the information processing method, and the program according to embodiments of the present technology, a behavior is evaluated from a self-viewpoint; the behavior is evaluated from another's viewpoint; and it is determined whether the behavior is performed from an evaluation result of the behavior from the self-viewpoint and an evaluation result of the behavior from the other's viewpoint

The information processing device may be an independent device or an internal block configuring one device.

The program can be transmitted via a transmission medium or recorded on a recording medium to be provided.

### BRIEF DESCRIPTION OF DRAWINGS

FIG. 1 is a diagram illustrating reinforced learning.

FIG. 2 is a diagram illustrating a configuration of an embodiment of an information processing device to which the present technology is applied.

FIG. 3 is a diagram illustrating an overview of an operation of a behavior evaluation module.

FIG. 4 is a diagram illustrating an exemplary configuration of the behavior evaluation module.

FIG. 5 is a diagram illustrating an exemplary configuration of an objective evaluation module.

FIG. 6 is a diagram illustrating an exemplary configuration of a self-viewpoint behavior evaluation module.

FIG. 7 is a diagram illustrating an exemplary configuration of an other's viewpoint behavior evaluation module.

FIG. 8 is a diagram illustrating an exemplary configuration of an integrated evaluation module.

FIG. 9 is a diagram illustrating an exemplary hardware configuration of the information processing device.

### DESCRIPTION OF EMBODIMENTS

Hereinafter, modes for carrying out the present technology (hereinafter referred to as embodiments) will be described.

The present technology can be applied to, for example, an information processing device that performs machine learning or an information processing device that performs processing using a learned model obtained as a result of the machine learning. As the machine learning, for example, reinforced learning can be used. As the reinforced learning, for example, a long short term memory (LSTM) can be used. Here, the LSTM applied to the present technology is described as an example. Machine learning (reinforced learning) in conformity with another scheme can also be applied.

### <LSTM>

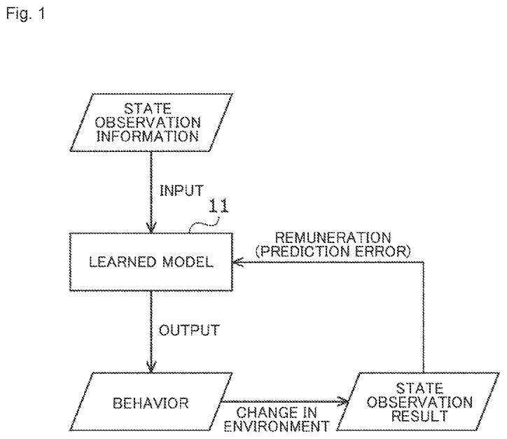

FIG. 1 is a diagram illustrating general reinforced learning network. A learned model 11 is, for example, a model obtained through reinforced learning using an LSTM. The LSTM is a model for time-series data in which a recurrent neural network (RNN) is extended. The LSTM has a feature in which long-term dependent learning is possible.

The learned model 11 has an appropriate evaluation function and outputs a behavior in which a predicted remuneration amount is the maximum based on environment state observation. As illustrated in FIG. 1, state observation information is input to the learned model 11. The learned model 11 determines an output based on the input state observation information. The output is, for example, a behavior which is subsequently performed.

When a behavior output from the learned model 11 is performed, an error between a prediction and a change given to an environment (a state observation result) is recognized and a prediction error is fed as a remuneration back to the learned model 11.

For example, when the learned model 11 is a model learned to determine a behavior of a robot, for example, information (for example, information such as an image, a sound, and a temperature) regarding an environment around the robot is obtained as the state observation information. The learned model 11 outputs, for example, a behavior such as rightward movement which is a route in which the robot travels based on the state observation information. The robot moves to the right by performing the output behavior.

For example, when an environment change in which the robot moves to the right and avoids an obstacle occurs, such an environment change is obtained as a state observation result. Then, an error between the state observation result and a prediction is fed as a remuneration back to the learned model 11. For example, when a behavior such as rightward movement is output to avoid an obstacle and the obstacle can be avoided as a result of the rightward movement, the error between the prediction and the state observation result is small. When the obstacle cannot be avoided, the error between the prediction and the state observation result is large.

The learned model 11 receiving such feedback performs learning so that a behavior for reducing an error is output at the next time.

The reinforced learning can be defined as learning in which feedback is performed on a learned model in such a manner that a change in an environment occurring as a result of a behavior performed by an agent (a behavior entity) is evaluated, the change is transferred as a remuneration based on a predetermined evaluation function, and the remuneration amount is maximized.

The learned model 11 is a model in which learning is performed so that a remuneration amount is maximized in a specific behavior entity, for example, when a specific robot, a user (a user group), or the like is a behavior entity. For example, a behavior entity is a robot A and learning is performed so that a remuneration amount for the robot A is maximized in the learned model 11.

When the robot A behaves based on the learned model 11, for example, the behavior may not be a behavior which is optimum for a robot B different from the robot A. For example, when the robot A changes its route to the right, which is the optimum behavior for the robot A, the robot B will collide with an obstacle because the robot A has changed its route to the right, and thus the behavior of the robot A can be said to be inappropriate for the robot B.

As another example, a case in which the learned model 11 is a system that generates dialogue or sentences, for example, a model learned for a chatbot, will be considered. The chatbot is an automated dialogue program in which artificial intelligence is utilized and a computer in which the artificial intelligence is embedded talks instead of a person. When reinforced learning related to a chatbot is performed, a behavior is generation of dialogue (sentences) or suggestion of dialogue (sentence) generated for a user and a remuneration amount is a reaction or the like of the user to whom the dialogue (sentences) is suggested.

Even in the learned model 11 that presents sentences with which remuneration amounts increase, sentences that may make users other than the specific user feel unpleasant are likely to be presented to specific users, for example, users in a specific age range, users living in a specific residential area, or the like. Sentences including inappropriate words compared to common sense or socially accepted ideas of a human society may be likely to be presented.

Thus, the learned model 11 in which an appropriate behavior can be performed in a specific system may be likely to be the learned model 11 in which inappropriate behaviors are performed in systems other than the specific system (hereinafter appropriately referred to as other systems).

For example, in the case of a system operating in cooperation with a plurality of systems, it is preferable to output a behavior optimum for an individual system included in the plurality of systems rather than outputting a behavior optimum to a specific system in the plurality of systems. For example, it is preferable not to present a sentence including inappropriate words compared to common sense, in other words, it is preferable to output a behavior in consideration of moral codes.

Hereinafter, a system that performs learning in which an optimum output is given in a system operating in cooperation with a plurality of systems or learning in which a behavior is output in consideration of moral codes will be described.

### <System Configuration>

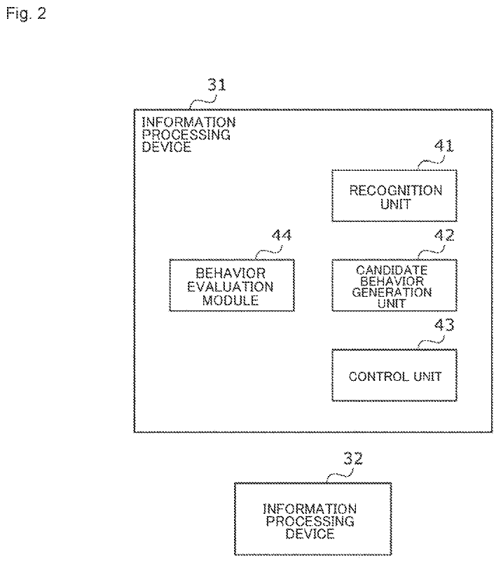

FIG. 2 is a diagram illustrating a configuration of an embodiment of an information processing system to which the present technology is applied. The information processing system illustrated in FIG. 2 includes two information processing devices 31 and 32.

The information processing device 31 performs an operation in an environment using a learned model learned by a predetermined machine learning method, for example, reinforced learning. The information processing device 31 is, for example, a device that controls a machine such as a robot or a car or a device that performs processing for a user (person) such as a chatbot.

The information processing device 31 may be, for example, a device included in a system that operates in cooperation with the information processing device 32. The cooperation includes a case in which processing is shared between the information processing devices 31 and 32 and work is performed to achieve the same goal. The information processing devices 31 and 32 perform separate work to achieve different goals. A case in which the information processing device 31 determines the own work of the information processing device 31 in consideration of the work of the information processing device 32 is also included.

For example, the information processing device 31 is assumed to be a device that controls the robot A and the information processing device 32 is assumed to be a device that controls the robot B. When the robots A and B share and perform work to achieve a goal A, the information processing device 31 determines work of the robot A in consideration of work of the robot B at the time of determination of the work of the robot A. For example, when rightward movement is determined as a behavior of the robot A, it is considered whether the movement of the robot A to the right interferes with the work of the robot B. When it is determined that it does not interfere with the work of the robot B, a behavior of movement to the right is output.

The information processing device 31 may be a device that outputs a behavior in consideration of moral codes, common sense, or the like in human society, a specific area, or the like. For example, when the information processing device 31 is a device that is applied to a chatbot and generates a sentence, a sentence is generated based on a learned model. A final sentence is generated in consideration of whether a generated sentence includes words or a discriminatory term that makes a person feel unpleasant compared to morals of general human society or morals (common sense) of a predetermined area.

The information processing device 31 is, for example, a device that performs processing based on a learned model learned so that an optimum output is performed for a specific user (referred to as a user A) and can also be configured as a device that determines a behavior in consideration of a user B different from the user A. For example, when a behavior (for example, advice offered to the user A) determined as a behavior of the user A by the learned model is performed by the user A and is a behavior particularly related to the user B, the information processing device 31 determines whether the behavior of the user A is also optimum for the user B and outputs a final behavior.

The information processing device 31 can also be configured as a device that determines whether the behavior performed by the user A is a behavior optimum for the user A and presents the behavior to the user. At the time of determination, a final result is output in consideration of whether the behavior is also behavior optimum for the user B who is a target of the behavior of the user A.

In this way, the information processing device 31 determines a self-behavior using whether the behavior is optimum for itself as a reference, and also determines whether the behavior is optimum for other systems, other users, or the like, determines a behavior, and outputs the behavior.

The information processing device 31 that performs such processing includes a recognition unit 41, a candidate behavior generation unit 42, a control unit 43, and a behavior evaluation module 44, as illustrated in FIG. 2. Here, the information processing device 31 will continue to be described as one device that has such functions, but it may be an information processing system in which a plurality of devices that individually have such functions are collectively configured.

The information processing device 31 has a different configuration depending on which device is controlled. For example, although not illustrated, a display unit, a sound output unit, a communication unit, a power unit, and the like can also be included.

In the following description, the information processing device 31 will be described as a self-system, and a system different from the self-system, for example, an information processing device 32 (see FIG. 2), will be described as another system.

The recognition unit 41 recognizes various states of the self-system, a state of an environment around the self-system, other devices which are or are likely to be in the environment, states of the other devices, and the like. The recognition unit 41 analyzes information obtained from a plurality of sensors and performs the recognition. As the sensors, for example, an image sensor, a microphone, a gyro sensor, an acceleration sensor, a temperature sensor, an atmospheric pressure sensor, a biological sensor, and the like can be used.

For example, the recognition unit 41 recognizes whether there is another system by analyzing an image captured by an image sensor or recognizes a direction in which the other system travels by tracking the other system. For example, the recognition unit 41 may perform recognition by communicating with the other system or another user through communication means.

For example, the recognition unit 41 can recognize the presence of a user or recognize a temperature or illuminance of a space where the user is and can obtain information for outputting a behavior for heating when the space where the user is cold or outputting a behavior for turning a light on when the space where the user is dark, for example, in processing of the rear stage.

The candidate behavior generation unit 42 generates candidates for a subsequent behavior which the self-system will control by using the information recognized by the recognition unit 41, such as the recognized self-system, the other system, and a situation of the environment. For example, the candidate behavior generation unit 42 generates behaviors such as continuing a present behavior, turning right, and generating a predetermined sentence as candidates.

A candidate behavior is preferably not an action but a behavior principle or a policy, but may be an action (for example, an implementation method such as control information or a movement route).

The control unit 43 controls each unit included in the self-system and each unit of a system coordinated with the self-system. A portion controlled by the control unit 43 differs depending on which device is controlled by the information processing device 31. For example, the control unit 43 controls a display device such as a display, a sound output device such as a speaker or a headphone, a printer device, or the like.

For example, the control unit 43 also performs control when a result obtained through various kinds of processing performed by the information processing device 31 is output. Specifically, the control unit 43 performs control such that the display device displays results obtained through various kinds of processing performed by the information processing device 31 as text or images. The control unit 43 also performs control such that the sound output device converts an audio signal formed from reproduced sound data, acoustic data, or the like into an analog signal and outputs the converted analog signal.

The control unit 43 controls a motor, a brake, or the like outputting information for movement control to each unit or performing movement control when the information processing device 31 functions as a part of a control unit that controls a vehicle or a robot. In the case of a device including a manipulator, the control unit 43 can also be configured to control the manipulator.

The control unit 43 can be configured to control each unit of the information processing device 31 in a central management manner and the control unit can also be provided in each unit and control each unit in a distributed management manner.

The behavior evaluation module 44 performs determination (control) of whether to actually output a candidate for a behavior generated by the candidate behavior generation unit 42 (hereinafter appropriately referred to as a candidate behavior). For example, when a behavior of rightward movement is output as a candidate behavior from the candidate behavior generation unit 42, it is determined whether the behavior of rightward movement is performed.

The behavior evaluation module 44 performs evaluation of a behavior performed by the user. For example, it is determined whether the behavior A performed by the user A is appropriate, and a result of the determination is output.

The behavior evaluation module 44 may be included in the information processing device 31 or may be included in a device different from the information processing device 31, for example, a server connected via a network.

### <Overview of Processing of Behavior Evaluation Module>

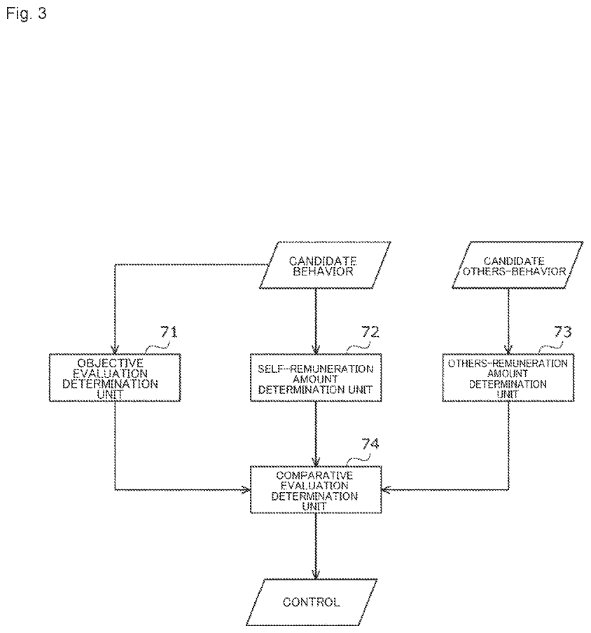

The determination performed by the behavior evaluation module 44 is considered to be determination in consideration of whether a behavior has an influence on the other system or is a moral problem. An overview of processing related to determination performed by the behavior evaluation module 44 will be described with reference to FIG. 3. In FIG. 3, a case in which it is determined whether a candidate behavior is performed will be described as an example.

The behavior evaluation module 44 outputs a final behavior by performing determination of an objective evaluation determination unit 71, determination of the self-remuneration amount determination unit 72, and determination of an other's remuneration amount determination unit 73 and causing a comparative evaluation determination unit 74 to compare results of the determinations.

Candidate behaviors are input to the objective evaluation determination unit 71 and the self-remuneration amount determination unit 72.

The objective evaluation determination unit 71 determines whether a candidate behavior is a behavior deviating from a social norm, for example, with reference to a database in which the social norm is stored. The social norm is, for example, a moral determination standard or a factor of common sense in general human society, a specific area, or the like. The objective evaluation determination unit 71 determines whether a candidate behavior deviates from such a social norm.

The self-remuneration amount determination unit 72 is a module that calculates a remuneration amount for a device, a person, or the like performing a candidate behavior. The self-remuneration amount determination unit 72 calculates and outputs a remuneration amount predicted from a behavior by a self-process and a remuneration system and taken by the user. The self-remuneration amount determination unit 72 predicts and outputs a behavior, in this case, a remuneration amount for a candidate behavior, for example, using a network of a reinforced learning system.

Another's candidate behavior is input to the other's remuneration amount determination unit 73. The other's candidate behavior is a behavior that is received by another device or another person when the candidate behavior is performed. For example, when the candidate behavior is a behavior in which the user A “beats the user B,” the user B performs a behavior in which the user B “is beaten by the user A.” “Being beaten by the user A” is another's candidate behavior.

As another example, a case of an automobile A and an automobile B approaching the automobile A will be considered. When a candidate behavior of the automobile A is a behavior of “turning right,” the automobile A turning right seems to perform a behavior in which “the automobile A turns to the left” from the viewpoint of the oncoming automobile B. Accordingly, in this case, a behavior in which “an oncoming automobile turns to the left” is another's candidate behavior.

Another's candidate behavior such as this is input to the other's remuneration amount determination unit 73. The other's remuneration amount determination unit 73 calculates and outputs a remuneration amount predicted from a behavior received by another person based on a process of the other person and a remuneration system. The other's remuneration amount determination unit 73 predicts and outputs a remuneration amount for a behavior of another, in this case, another's candidate behavior, for example, using a network of a reinforced learning system. The other's remuneration amount determination unit 73 can be said to be a simulation function of setting how a remuneration amount for another is set and how the remuneration amount changes at the time of replacement for another rather than oneself.

An output from the other's remuneration amount determination unit 73 may involve outputting a remuneration amount adjusted for the degree of a relation with oneself. For example, the remuneration amount to be output may be adjusted in accordance with the degree of intensity of a relation with oneself, the degree of how important a partner is to oneself, the degree of sympathy for the partner, or the like.

The comparative evaluation determination unit 74 is a module that integrates outputs from the objective evaluation determination unit 71, the self-remuneration amount determination unit 72, and the other's remuneration amount determination unit 73. The determination results are input to the comparative evaluation determination unit 74 and the determination results are compared to each other to determine whether a candidate behavior is actually performed or is not performed.

An overview of processing performed by the behavior evaluation module 44 will be described by giving an example. Here, a case in which the behavior evaluation module 44 evaluates a behavior performed by the user A as an evaluation target and recommends a behavior to the user A will be described as an example.

When the candidate behavior generation unit 42 generates a candidate behavior such as “beating the shoulder of the user B” as a candidate for the behavior performed by the user A, the candidate behavior is set as a processing target of the objective evaluation determination unit 71 and the self-remuneration amount determination unit 72.

When data such as “it is not good to beat” and “it is good to beat a shoulder” is stored in a database referred to by the objective evaluation determination unit 71, the objective evaluation determination unit 71 outputs an evaluation such as “good” for the candidate behavior “beating the shoulder of the user B” and outputs the evaluation to the comparative evaluation determination unit 74.

The self-remuneration amount determination unit 72 includes a learned model obtained through reinforced learning with regard to a behavior performed by the user A. The self-remuneration amount determination unit 72 calculates a remuneration amount for a behavior “beating the shoulder of the user B” using the learned model. When learning indicating that, for example, the user A hates because of being exhausted when beating a shoulder is performed in the learned model, a remuneration amount of a low value is output as a remuneration amount for the candidate behavior “beating the shoulder of the user B.”

An other's candidate behavior obtained by converting the candidate behavior “beating the shoulder of the user B” into a behavior at the time of viewing from the viewpoint of the user B is input to the other's remuneration amount determination unit 73. When the user B sees the candidate behavior such as “the user A beats the shoulder of the user B,” the shoulder is beaten by the user A. Therefore, the behavior “the shoulder is beaten by the user A” is input as an other's candidate behavior to the other's remuneration amount determination unit 73.

The other's remuneration amount determination unit 73 has an evaluation function related to a behavior performed by the user B. As will be described below, for example, when a learned model related to the user B is obtained as the evaluation function related to the behavior performed by the user B, the obtained learned model can be used. When the learned model related to the user B is not obtained, a learned model of the user A (an evaluation function related to a behavior performed by the user A) may be used.

The other's remuneration amount determination unit 73 calculates a remuneration amount for the behavior “the shoulder is beaten by the user A” using the learned model. When learning indicating that, for example, the user B feels good when his or her shoulder is beaten is performed in the learned model, a remuneration amount of a high value is output as a remuneration amount for the other's candidate behavior “the shoulder is beaten by the user A.”

The comparative evaluation determination unit 74 determines whether the user A is caused to perform (the user A moves to perform) the candidate behavior “the user A beats the shoulder of the user B.” The comparative evaluation determination unit 74 supplies the three input determination results (remuneration amounts), in this case, a determination result indicating “good” from the objective evaluation determination unit 71, a remuneration amount of a low value from the self-remuneration amount determination unit 72, and a remuneration amount of a high value from the other's remuneration amount determination unit 73.

For example, when the comparative evaluation determination unit 74 determines by majority decision whether the candidate behavior is performed, in the case of this example, a determination result indicating that the candidate behavior “the user A beats the shoulder of the user B” is recommended to the user A is output. In this way, the determination of the behavior evaluation module 44 is performed in consideration of the oneself, others, and the social norms.

### <Configuration of Evaluation Behavior Module>

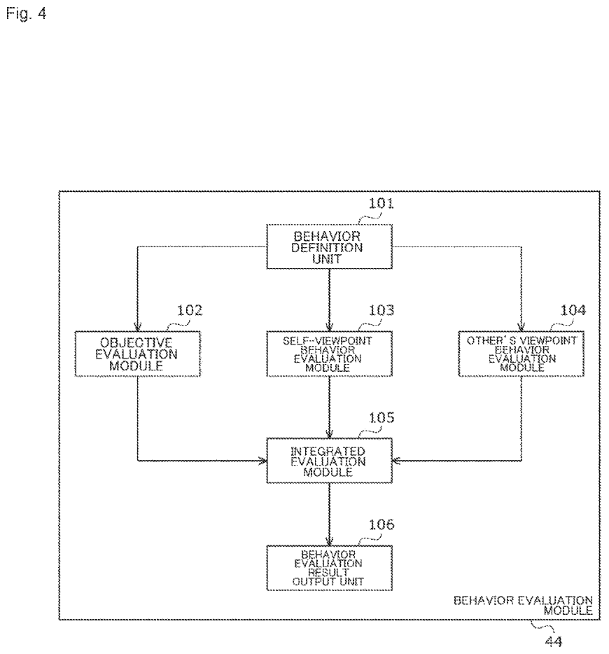

FIG. 4 is a diagram illustrating an exemplary configuration of the behavior evaluation module 44. The behavior evaluation module 44 includes a behavior definition unit 101, an objective evaluation module 102, a self-viewpoint behavior evaluation module 103, an other's viewpoint behavior evaluation module 104, an integrated evaluation module 105, and a behavior evaluation result output unit 106.

The objective evaluation module 102, the self-viewpoint behavior evaluation module 103, the other's viewpoint behavior evaluation module 104, and the integrated evaluation module 105 correspond to the objective evaluation determination unit 71, the self-remuneration amount determination unit 72, the other's remuneration amount determination unit 73, and the comparative evaluation determination unit 74 illustrated in FIG. 3, respectively.

The behavior definition unit 101 defines information corresponding to the foregoing candidate behavior, that is, an evaluation target behavior. The behavior definition unit 101 can be configured so that the evaluation target behavior specified by another system or another module is input. The behavior is a behavior scheduled to be performed by the self-system (corresponding to a candidate behavior) or a behavior performed by the self-system.

For example, the candidate behavior generated by the candidate behavior generation unit 42 is input. For example, when a server controlling a plurality of robots sets a “movement route change” as a candidate behavior in a predetermined robot, the server may supply the candidate behavior “movement route change” to the behavior definition unit 101 of the behavior evaluation module 44 included in the predetermined robot.

The behavior evaluation module 44 may be configured to monitor a behavior scheduled by the self-system and perform active evaluation or intervention control. For example, various kinds of control information of the robots which are included in the self-system and are control target of the self-system are observed, a candidate for a control behavior which can be taken subsequently is recognized as the “movement route change,” and the behavior such as the recognized “movement route change” may be defined as an evaluation target by the behavior definition unit 101.

The behavior definition unit 101 obtains or recognizes and defines subsequent information regarding an evaluation target candidate behavior. The behavior definition unit 101 obtains or recognizes information regarding a goal behavior or defines the obtained or recognized information as information regarding the goal behavior. As the information regarding the goal behavior, for example, information classified for the goal of a behavior such as the movement route change is obtained and this information is defined as information regarding the goal behavior.

The behavior definition unit 101 obtains or recognizes information regarding control of a behavior and defines the obtained or recognized information as information regarding the control of the behavior. As the information regarding the control of the behavior, for example, information such as control information or recognition information generated in the self-system is obtained to implement the goal behavior such as a specific route or control information, and this information is defined as the information regarding the control of the behavior.

The behavior definition unit 101 obtains or recognizes environmental information regarding a behavior and defines the obtained or recognized information as the environmental information regarding the behavior. The environmental information is, for example, environmental sensing information obtained through sensing, reception information from an environment, or the like. The environmental information is information regarding other systems which are in the environment, other system recognition information, or the like. The behavior definition unit 101 acquires, for example, the environmental sensing information and defines the acquired information as the environmental information regarding the behavior.

The objective evaluation module 102 corresponds to the objective evaluation determination unit 71 (see FIG. 3) and is a module that evaluates a candidate behavior based on social norms or the like.

The self-viewpoint behavior evaluation module 103 corresponds to the self-remuneration amount determination unit 72 (see FIG. 3) and is a module that evaluates a candidate behavior from the self-viewpoint.

The other's viewpoint behavior evaluation module 104 corresponds to the other's remuneration amount determination unit 73 (see FIG. 3) and is a module that evaluates a candidate behavior from the other's viewpoint.

The integrated evaluation module 105 corresponds to the comparative evaluation determination unit 74 (see FIG. 3), integrates evaluation results evaluated by the objective evaluation module 102, the self-viewpoint behavior evaluation module 103, and the other's viewpoint behavior evaluation module 104, determines whether an evaluation target behavior is performed, and outputs a determination result.

The behavior evaluation result output unit 106 outputs an evaluation result from the integrated evaluation module 105 to a corresponding unit. For example, when an evaluation indicating that a behavior is performed is given, behavior information which will be performed is output to the control unit that controls the behavior.

An evaluation result output from the integrated evaluation module 105 is, for example, information indicating that a behavior is performed or a behavior is not performed, for example, information of 0/1 indicating that 1 is set in a case in which the behavior is performed and 0 is set in a case in which the behavior is not performed. The evaluation result may be a probability (%) indicating that it is good to perform a behavior. Specific information for inhibiting a candidate behavior may be output as an evaluation result.

The behavior evaluation module 44 to which the present technology is applied includes, as modules that evaluate a behavior, three evaluation modules, the objective evaluation module 102, the self-viewpoint behavior evaluation module 103, and the other's viewpoint behavior evaluation module 104, as illustrated in FIG. 4. Hereinafter, description of the three evaluation modules will be added.

Each of the objective evaluation module 102, the self-viewpoint behavior evaluation module 103, and the other's viewpoint behavior evaluation module 104 may be a network that is learned independently.

The behavior evaluation module 44 may include two evaluation modules among the objective evaluation module 102, the self-viewpoint behavior evaluation module 103, and the other's viewpoint behavior evaluation module 104. Even in a case in which the three evaluation modules are included, evaluation may not necessarily be performed using the three evaluation modules when only two of the evaluation modules are used, depending on a behavior which will be evaluated.

For example, in the case of a system that operates under the environment in which it is not necessary to determine moral codes, the objective evaluation module 102 may not be included. For example, in the case of a mobile object that autonomously travels within a predetermined range, the objective evaluation module 102 may not be included.

### <Configuration and Operation of Objective Evaluation Module>

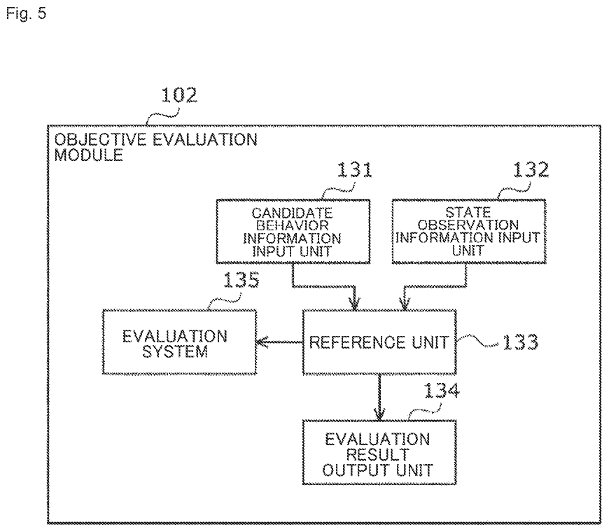

FIG. 5 is a diagram illustrating an exemplary configuration of the objective evaluation module 102. The objective evaluation module 102 includes a candidate behavior information input unit 131, a state observation information input unit 132, a reference unit 133, an evaluation result output unit 134, and an evaluation system 135.

The candidate behavior information input unit 131 inputs a candidate behavior (an evaluation target behavior) output from the behavior definition unit 101 (see FIG. 4). The state observation information input unit 132 inputs state observation information output from the behavior definition unit 101 (see FIG. 4).

The reference unit 133 evaluates a candidate behavior with reference to the evaluation system 135. The evaluation result output unit 134 supplies an evaluation result from the reference unit 133 to the integrated evaluation module 105 (see FIG. 4).

The evaluation system 135 includes, for example, a database that stores evaluation values of various behaviors in a predetermined environment. For example, the evaluation system 135 may be a general or average learning network capable of evaluating the behaviors in the predetermined environment.

The database or the learning network of the evaluation system 135 relates to a “moral determination standard” or “common sense.” The “moral determination standard” or the “common sense” is a rule or a reference serving as codes in a specific environment and a system in the environment is obliged to observe the moral determination standard or the common sense or respect thereof is recommended.

The specific environment is, for example, a general human society, a specific area, a specific social graph region, a providing environment of a predetermined service, a region defined by a system, or the like.

A specific example of the database or the learning network of the evaluation system 135 is related to common sense or socially accepted ideas of a human society, criterions or prohibition matters (for example, terms, actions, restricted areas considered to be inappropriate) applied in specific areas, specific organizations, or specific local environments, or the like.

The database or the learning network of the evaluation system 135 is related to, for example, law, social norms, traffic rules, or the like. Rules or the like specific to a predetermined area or a predetermined user may be used. A dictionary may be used, or a data base or a learning network in which words such as discriminatory terms which are better not to use are managed may be used. In the case of the learning network, a learned function may be managed.

The evaluation system 135 can be included in the objective evaluation module 102. The evaluation system 135 is no included in the objective evaluation module 102 and can be provided outside of the objective evaluation module 102. When the evaluation system 135 is provided outside of the objective evaluation module 102, the reference unit 133 is considered to refer to the evaluation system 135 via a network.

The evaluation system 135 may be configured with a plurality of databases or learning networks and the reference unit 133 may be configured to access the evaluation system 135 appropriate to evaluate an evaluation target candidate behavior.

For example, a database (or a learning network: hereinafter a database will be given as an example in the following description) related to custom of each province is assumed to be constructed for each province as the evaluation system 135. In this case, for example, the reference unit 133 specifies an area from information regarding an environment supplied from the state observation information input unit 132, accesses the evaluation system 135 including a database related to custom of the area, and causes the evaluation system 135 to evaluate an evaluation target candidate behavior.

In this way, the evaluation system 135 is configured with a plurality of databases to perform evaluation with reference to an appropriate database. For example, when a sentence is generated by a chatbot, it is evaluated whether words of a sentence considered as a candidate are words appropriate for people of the province.

The database of the evaluation system 135 can be a database in which prohibition matters are described in the environment. The prohibition matters in the environment are, for example, inappropriate matters, compared to common sense or socially accepted ideas of a human society. For example, words (for example, discriminatory terms or the like) which make people unpleasant and NG words which are prohibited from being used in a conversation robot such as a chatbot correspond to the prohibition matters in the environment. The prohibition matters in the environment are, for example, behaviors (gestures) which make people unpleasant. Since the prohibition matters are likely to be changed with a period or a situation, a database that stores the prohibition matters are updated. The prohibition matters in the environment are, for example, prohibition of intrusion into a specific region of an autonomous traveling vehicle or prohibition of turning movement in a specific situation such as a case in which there is an oncoming vehicle.

For example, when an autonomously traveling automobile turns right at an intersection (in the case of a candidate behavior such as turning right), how much the turn-right behavior is appropriate (how much a turn-right timing is early or late, in particular, whether passing of an oncoming vehicle is prioritized as custom of a province when there is an oncoming vehicle which will go straight) is inquired of the evaluation system 135 optimized to a province A at the time of traveling in province A and the evaluation system 135 optimized to a province B at the time of traveling in province B.

In this way, the reference unit 133 evaluates a candidate behavior input via the candidate behavior information input unit 131 with reference to the evaluation system 135. The reference unit 133 also uses information from the state observation information input unit 132 to set the evaluation system 135 which will be referred to, as necessary.

The objective evaluation module 102 evaluates whether a candidate behavior is an appropriate behavior compared to social norms, general common sense, or the like and outputs the evaluation result to the integrated evaluation module 105.

The evaluation result can be set to, for example, −1 or 1. For example, −1 is output in the case of an evaluation result indicating that it is better to inhibit the candidate behavior, and 1 is output in the case of an evaluation result indicating that it is better to perform the candidate behavior. Of course, for the evaluation result, a value indicating the degree (percentage) that it is better to inhibit a candidate behavior as a continuous value or the degree that performing a candidate behavior is recommended may be output as an evaluation result.

### <Configuration and Operation of Self-Viewpoint Behavior Evaluation Module>

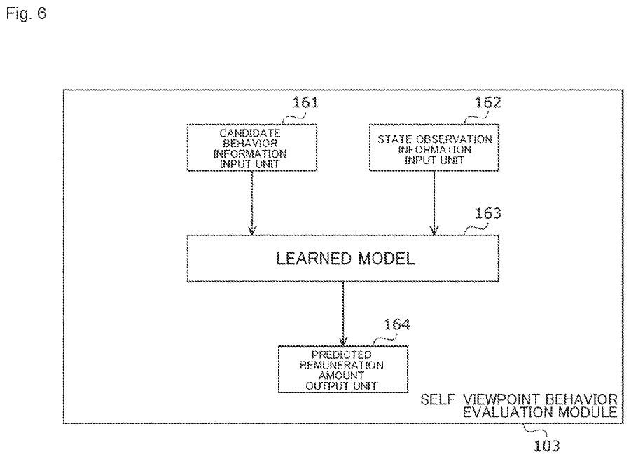

FIG. 6 is a diagram illustrating an exemplary configuration of the self-viewpoint behavior evaluation module 103. The self-viewpoint behavior evaluation module 103 includes a candidate behavior information input unit 161, a state observation information input unit 162, a learned model 163, and a predicted remuneration amount output unit 164.

The candidate behavior information input unit 161 inputs a candidate behavior (an evaluation target behavior) output from the behavior definition unit 101 (see FIG. 4). The state observation information input unit 162 inputs state observation information output from the behavior definition unit 101 (see FIG. 4). The state observation information is, for example, self-system state information, various kinds of information regarding an environment, information regarding other systems which are in the environment, and various kinds of information related thereto.

The learned model 163 is a learned model which is learned from a reinforced learning network and is a network in which a behavior maximizing a predicted remuneration amount is determined. The learned model 163 corresponds to the learned model 11 in the description made with reference to FIG. 1. The learned model 163 can be a learned model learned by the LSTM.

Here, the LSTM will be described as an example. However, the learned model 163 learned in accordance with another learning method can also be used. A model constructed in accordance with another method may be used without being limited to reinforced learning.

The learned model 163 included in the self-viewpoint behavior evaluation module 103 is a learned model learned to predict a behavior maximizing a remuneration amount in the self-system. The self-viewpoint behavior evaluation module 103 inputs a candidate behavior input by the candidate behavior information input unit 161 to the learned model 163 and outputs a remuneration amount predicted in a case in which the candidate behavior is performed as a behavior evaluation result (a predicted remuneration amount).

The predicted remuneration amount can be set to, for example, a value of −1 to 1. For example, a value close to −1 is output as a predicted remuneration amount in a case in which the degree that it is better to inhibit the candidate behavior is strong. A value close to 1 is output as a predicted remuneration amount in a case in which the degree that it is better to perform the candidate behavior is strong. Of course, a discrete value may be used as the predicted remuneration amount. −1 may be output in a case in which it is better to inhibit the candidate behavior and 1 may be output in a case in which it is better to perform the candidate behavior.

In accordance with an evaluation target candidate behavior, an appropriate model can also be selected as the learned model 163 or an evaluation function used for evaluation. As the evaluation function, an evaluation function different in accordance with a situation of the self-system can also be selected. For example, a different evaluation function can be used when a remaining amount of a battery is large or small. For example, an evaluation result can also be given so that power reduction or power guarantee is prioritized when the remaining amount of the battery is small.

The learned model or the evaluation function is not one kind of learned model or evaluation function. A plurality of learned models or evaluation functions may be selected for evaluation multidimensionally. In this case, the evaluation result may be expressed as a space for predicted remuneration. For example, when a movement route is evaluated, a plurality of evaluations may be performed including an evaluation from the viewpoint of arrival at a highest speed and an evaluation from the viewpoint of arrival at a low risk.

In the learned model 163, learning may be continuously performed, as described with reference to FIG. 1. A candidate behavior evaluated by the learned model 163 may be actually performed, an environmental change occurring when the behavior is performed may be recognized, the environmental change may be fed back as a remuneration amount to the learned model 163, and the learning may be continuously performed.

The self-viewpoint behavior evaluation module 103 evaluates the candidate behavior from the self-viewpoint and the evaluation result may be output to the integrated evaluation module 105.

### <Configuration and Operation of Other's Viewpoint Behavior Evaluation Module>

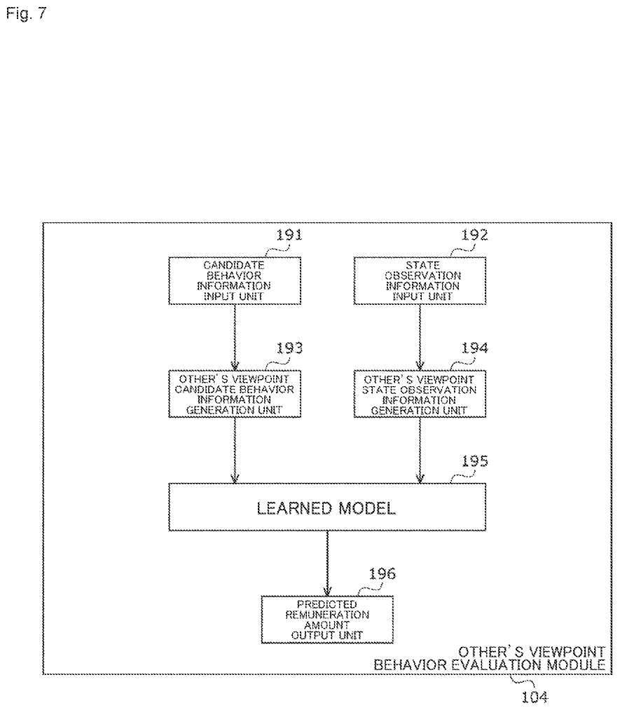

FIG. 7 is a diagram illustrating an exemplary configuration of the other's viewpoint behavior evaluation module 104. The other's viewpoint behavior evaluation module 104 includes a candidate behavior information input unit 191, a state observation information input unit 192, an other's viewpoint candidate behavior information generation unit 193, an other's viewpoint state observation information generation unit 194, a learned model 195, and a predicted remuneration amount output unit 196.

The candidate behavior information input unit 191 inputs a candidate behavior (an evaluation target behavior) output from the behavior definition unit 101 (see FIG. 4). The state observation information input unit 192 inputs the state observation information output from the behavior definition unit 101 (see FIG. 4).

The candidate behavior information input unit 191 and the state observation information input unit 192 of the other's viewpoint behavior evaluation module 104 have the same configurations as the candidate behavior information input unit 161 and the state observation information input unit 162 of the self-viewpoint behavior evaluation module 103 and are units that input similar information. The units can be provided separately and can also be shared.

The other's viewpoint behavior evaluation module 104 is a module that substitutes a behavior of the self-system with a behavior viewed from another system and evaluates the behavior viewed from the other system from the viewpoint of the other system when the self-system is viewed from the other system, for example, in the example illustrated in FIG. 2, the information processing device 31 which is the self-system is viewed from the information processing device 32 which is the other system.

Since the behavior of the self-system is substituted with a behavior at the time of viewing from the other system, the other's viewpoint behavior evaluation module 104 includes the other's viewpoint candidate behavior information generation unit 193 and the other's viewpoint state observation information generation unit 194.

The other's viewpoint candidate behavior information generation unit 193 generates a behavior observed from the other system with regard to a candidate behavior of the self-system when the candidate behavior is performed by the self-system. The other's viewpoint candidate behavior information generation unit 193 generates a behavior described as an other's candidate behavior in the description made with reference to FIG. 3. For example, when a candidate behavior of the moving and traveling self-system is a behavior of turning right, the oncoming traveling other system can ascertain that the behavior is a behavior in which the moving object in front is turning left.

Accordingly, in the case of this example, the candidate behavior of turning right is input from the candidate behavior information input unit 191 to the other's viewpoint candidate behavior information generation unit 193. Then, the other's viewpoint candidate behavior information generation unit 193 generates behavior information indicating that the moving object in front turns left as the other's candidate behavior and outputs the behavior information to the learned model 195.

The other's viewpoint state observation information generation unit 194 converts the environmental information of the self-system into environmental information of the self-system viewed from the other system. The other's viewpoint state observation information generation unit 194 can be configured to convert the environmental information of the self-system into environmental information of an other's viewpoint as necessary, and can be configured not to perform the conversion processing when the conversion is not necessary.

For example, when the self-system and the other system are under the same environment, processing for converting environmental information of the self-system into environmental information of the other system can be omitted. For example, when the environmental information of the self-system is information indicating that there is a fence to the left, there is the fence to the right from the viewpoint of the oncoming other system. Therefore, processing for converting the environmental information into the environmental information indicating that there is the fence to the right is performed.

The other's viewpoint state observation information generation unit 194 may convert the environmental information of the self-system into the environmental information of the other system. For example, when the self-system is a system corresponding to a person living in a district A and the other system is a system corresponding to a person living in a district B different from the district A, there is a difference in an environment such as a time or a temperature or there is custom between the self-system and the other system. Accordingly, in the case of this example, the other's viewpoint state observation information generation unit 194 converts the time or the temperature into a time or a temperature of the district B when the time or the temperature is input as state observation information.

The other's viewpoint state observation information generation unit 194 can also be configured to be supplied with environmental information acquired by the other system from the other system.

The learned model 195 is a learned model which is learned from, for example, a reinforced learning network and is a network in which a behavior maximizing a predicted remuneration amount is determined. The learned model 195 corresponds to the learned model 11 in the description made with reference to FIG. 1 and can be a learned model learned by the LSTM, as in the learned model 163 (see FIG. 6).

The learned model 195 included in the other's viewpoint behavior evaluation module 104 is a learned model that is learned to predict a behavior maximizing a remuneration amount in the other system. The other's viewpoint behavior evaluation module 104 inputs an other's candidate behavior generated by the other's viewpoint candidate behavior information generation unit 193 to the learned model 195 and outputs a remuneration amount predicted in a case in which the other's candidate behavior is performed as a behavior evaluation result (a predicted remuneration amount).

The predicted remuneration amount can be set to, for example, a value of −1 to 1. For example, a value close to −1 is output as a predicted remuneration amount in a case in which the degree that it is better to inhibit the other's candidate behavior is strong. A value close to 1 is output as a predicted remuneration amount in a case in which the degree that it is better to perform the other's candidate behavior is strong. Of course, a discrete value may be used as the predicted remuneration amount. −1 may be output in a case in which it is better to inhibit the other's candidate behavior and 1 may be output in a case in which it is better to perform the other's candidate behavior.

As in the learned model 195 or the foregoing learned model 163 (see FIG. 6), in accordance with an evaluation target other's candidate behavior, an appropriate model can also be selected as the learned model 195 or an evaluation function used for evaluation. As the evaluation function, an evaluation function different in accordance with a situation of the other system can also be selected.

The learned model or the evaluation function is not one kind of learned model or evaluation function. A plurality of learned models or evaluation functions may be selected for evaluation multidimensionally. The learned model 195 may be continuously learned, as described with reference to FIG. 1.

The other's viewpoint behavior evaluation module 104 may evaluate a user (a person) as an evaluation target. When a person is evaluated as an evaluation target, a so-called user model (in this case, the learned model 195) for the user (the person) is formed in accordance with interaction with the user (the person), and the other's viewpoint behavior evaluation module 104 may allow the user to perform optimization with a time change.

The other's viewpoint behavior evaluation module 104 evaluates a candidate behavior from an other's viewpoint and outputs the evaluation result to the integrated evaluation module 105.

The other's viewpoint behavior evaluation module 104 is a module that evaluates a candidate behavior from the other's viewpoint (the other system). Therefore, the learned model 195 learned from the other's viewpoint (the other system) is used. The other's viewpoint behavior evaluation module 104 of the self-system may include the learned model 195 learned in the other system. The learned model 195 may be acquired (downloaded) using communication means.

The other's viewpoint behavior evaluation module 104 of the self-system may not include the learned model 195, may access the other system as necessary, and may be configured to use the learned model 195 managed by the other system. The learned model 195 may be shared with the other system.

When the learned model 195 managed by the other system is used, the other system which is a target may be changed and another system of the change destination may be accessed. An other's candidate behavior can be evaluated using the learned model 195 optimized to the other system.

As the learned model 195 included in the other's viewpoint behavior evaluation module 104, the learned model 163 included in the self-viewpoint behavior evaluation module 103 may be used (the learned model 163 may be shared as the learned model 195). In this case, an other's benefit is assumed from an other's standpoint by using self-values.

For example, when a candidate behavior related to the user A is “beating the shoulder of the user B,” the behavior is a “the shoulder is beaten by the user A” from the viewpoint of the user B. In the case of the learned model 195 (the learned model 163) learned so that the user A feels pleased when his or her shoulder is beaten, it is inferred that the user B is also pleased when his or her shoulder is beaten and an evaluation of “pleased” is given.

In this case, when the users A and B have the same sensation, values, ideas, or the like, the evaluation can be performed without considerably deviating inference. Accordingly, the learned model 163 can be used as the learned model 195.

When a learned model (an evaluation function) of the other system is known and inference is possible, a predicted remuneration amount may be calculated using the learned model (the evaluation function). Compared to this, this corresponds to inference of the values of a friend and imagination of a benefit from a standpoint of the friend.

The case in which the learned model of the other system is known is a case in which the learned model of the other system is shared or a case in which the learned model of the other system can be assessed. The case in which the learned model of the other system can be inferred is, for example, a case in which a learned model of the other system is generated, that is, can be inferred, by performing learning using a learned model of a system similar to the other system which can be shared or accessed.

For example, when a learned model of the other system is publicized, the publicized learned model may be used as the learned model 195. For example, in the case of other systems resembling the self-system, for example, robots operating in the same factory, the learned model of the other systems may be assumed to be similar to the learned model of the self-system and the learned model of the other systems may be predicted and used from the learned model of the self-system.

In this way, the other's viewpoint behavior evaluation module 104 evaluates a candidate behavior from the other's viewpoint and outputs the evaluation result to the integrated evaluation module 105.

The number of other's viewpoint behavior evaluation modules 104 performing such processing may be singular or plural. In other words, as the other system, one system may be targeted and processed or a plurality of systems may be targeted and processed.

When a plurality of systems are targeted and processed and the plurality of other's viewpoint behavior evaluation modules 104 are included, the plurality of other's viewpoint behavior evaluation modules 104 illustrated in FIG. 7 may be configured or the plurality of learned models 195 in the other's viewpoint behavior evaluation module 104 may be configured.

When the plurality of other's viewpoint behavior evaluation modules 104 are configured and, for example, there are a plurality of other systems in an environment, evaluation can be performed for each of the other systems and each evaluation result can be output. In this case, the plurality of obtained evaluation results may be output to the integrated evaluation module 105 at the rear stage without being changed. For example, an average value or a median value of the plurality of evaluation results can be calculated and the average value or the medium value can be output.

When the plurality of other systems are targeted and an evaluation result is output for each of the other systems, weighting is performed for each of the other systems and each weighted evaluation result may be output to the integrated evaluation module 105. Alternatively, an average value or a median value of the weighted evaluation results may be calculated and may be summarized to one evaluation result to be output to the integrated evaluation module 105.

For example, when the number of other systems is greater than the number of other systems targeted as processing targets of the other's viewpoint behavior evaluation module 104, other systems which are evaluation targets are appropriately selected from the plurality of other systems. Random sample selection may be performed as the selection or representative other systems may be selected.

Other systems that have a large influence among the plurality of other systems may be selected. The other systems that have a large influence are, for example, other systems close to the self-system or other systems that have an influence on the self-system from now on. Other systems that have a strong relation with the self-system, for example, other systems that behave in cooperation with the self-system, may be selected.

The other's viewpoint behavior evaluation module 104 may perform weighting in accordance with states of the other systems which are evaluation targets and output evaluation results. For example, the weighting may be performed in such a manner that weights of the evaluation results of the other systems that have a strong relation are heavy and weights of the evaluation results of the other systems that have a weak relation are light. The other systems that have the strong relation in this case are, for example, other systems that have an influence from now on.

The weighting may be performed in accordance with whether the other systems are more sympathetic. For example, when the other systems are systems related to people (for example, systems concerned in a chatbot), systems of people living in a predetermined district are the other systems that are highly sympathetic.

The priorities may be given to the other systems and weighting may be performed in accordance with the priorities. The priorities can be set in the order in which a predetermined condition is satisfied or in the order set in advance by users, managers, or the likes of the systems.

The other's viewpoint behavior evaluation module 104 may perform weighting in accordance with uncertainty of the learned model 195 (the evaluation model) related to the other system which is an evaluation target and output an evaluation result. For the weight in accordance with the uncertainty, a weight of an evaluation result when the highly reliable learned model 195 is used is considered to be heavy and a weight of an evaluation result when the lowly reliable learned model 195 is used is considered to be light.

When the reliability is determined to be high or low, for example, the reliability is determined to be high in the case of the well-known other systems, for example, systems related to acquaintances and the reliability is determined to be low in the case of well-unknown other systems, for example, systems related to others.

When the reliability of an evaluation result is low (when the learned models 195 of the well-unknown other systems are used), an average value of assumed remuneration amounts of the plurality of systems may be calculated and the average value may be output.

In this way, the other's viewpoint behavior evaluation module 104 evaluates a candidate behavior from an other's viewpoint and outputs the evaluation result to the integrated evaluation module 105.

### <Configuration and Operation of Integrated Evaluation Module 105>

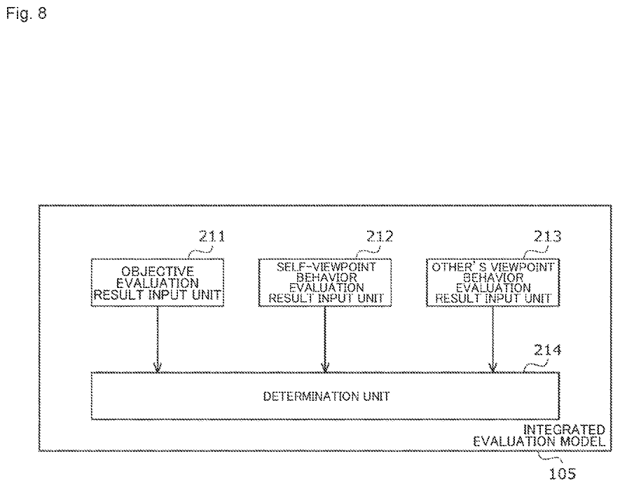

FIG. 8 is a diagram illustrating an exemplary configuration of the integrated evaluation module 105. The integrated evaluation module 105 includes an objective evaluation result input unit 211, a self-viewpoint behavior evaluation result input unit 212, an other's viewpoint behavior evaluation result input unit 213, and a determination unit 214.

The objective evaluation result input unit 211 inputs an evaluation result from the objective evaluation module 102 to supply the evaluation result to the determination unit 214. The self-viewpoint behavior evaluation result input unit 212 inputs an evaluation result from the self-viewpoint behavior evaluation module 103 to supply the evaluation result to the determination unit 214. The other's viewpoint behavior evaluation result input unit 213 inputs an evaluation result from the other's viewpoint behavior evaluation module 104 to supply the evaluation result to the determination unit 214.

The determination unit 214 outputs a final evaluation result of the candidate behavior based on the evaluation result from the objective evaluation module 102, the evaluation result from the self-viewpoint behavior evaluation module 103, and the evaluation result from the other's viewpoint behavior evaluation module 104 (hereinafter appropriately referred to as the evaluation results of the three modules).

Here, a case in which the final evaluation result of the candidate behavior is output based on the evaluation results of the three modules will be continuously described as an example. However, the final evaluation result of the candidate behavior can also be given based on the evaluation results of two modules, the evaluation result from the self-viewpoint behavior evaluation module 103 and the evaluation result from the other's viewpoint behavior evaluation module 104.

The final evaluation result of the candidate behavior output from the determination unit 214 is, for example, information indicating whether the candidate behavior is inhibited. A recommendation value indicating how much the candidate behavior is recommended may be used.

When the recommendation value is output, the determination unit 214 may calculate the recommendation value for each of a plurality of behaviors, compare the plurality of calculated recommendation values with each other, and output the final determination result. For example, as a result of the comparison of the recommendation values, a behavior that has a highest recommendation value may be output.

The determination unit 214 can be configured to use a plurality of schemes and perform determination (output the final determination result) by switching a determination method in accordance with a situation. Of course, the final determination result may be output using one scheme.

As a determination method performed by the determination unit 214, for example, an AND scheme can be applied.

In the case of the AND scheme, when a reference value is set and all of the evaluation results of the three modules do not satisfy the reference value, the determination result indicating that the candidate behavior is inhibited is given. Even when two evaluation results do not satisfy the reference value among the evaluation results of the three modules, a determination result indicating that a candidate behavior is inhibited may be given.

For example, when the evaluation result from the objective evaluation module 102 does not satisfy the reference value among the evaluation results of the three modules, the determination result indicating that a candidate behavior is inhibited may be given even if the evaluation result of the self-viewpoint behavior evaluation module 103 and the evaluation result of the other's viewpoint behavior evaluation module 104 are good. For example, when the evaluation of the objective evaluation module 102 is evaluation for the degree that the evaluation of the objective evaluation module 102 obeys moral codes or law, the evaluation result from the objective evaluation module 102 indicates whether a behavior is within an allowed range compared with the moral codes, the law, or the like.

Accordingly, the case in which the evaluation result from the objective evaluation module 102 does not satisfy the reference value is a case in which it is determined that an evaluation target candidate behavior is not a behavior within the allowed range compared with the moral codes, the law, or the like. When such a behavior is performed, there is a possibility of violation of the moral codes, the law, or the like. Therefore, a determination result indicating that the behavior is inhibited is given.

For example, when the evaluation result from the other's viewpoint behavior evaluation module 104 does not satisfy the reference value among the evaluation results of the three modules, the determination result indicating the candidate behavior is inhibited may be given even if the evaluation result of the objective evaluation module 102 and the evaluation result of the self-viewpoint behavior evaluation module 103 are good.

When the evaluation result from the other's viewpoint behavior evaluation module 104 does not satisfy the reference value and a candidate behavior is performed, there is a possibility of being disadvantageous to the others (the other systems). To inhibit a behavior which is likely to be disadvantageous to the others, the determination result indicating that the candidate behavior is inhibited may be given when the evaluation result from the other's viewpoint behavior evaluation module 104 does not satisfy the reference value.

As another determination method performed by the determination unit 214, for example, an integration scheme can be applied.

In the case of the integration scheme, statistical processing of an average value, the median value, or the like of the evaluation results of the three modules is performed and the final determination result is given using a value obtained after the statistical processing. For example, when the value obtained after the statistical processing is equal to or less than the reference value, the determination result indicating that the candidate behavior is inhibited may be given. In the case of the integration scheme, well-balanced determination can be performed.

When the integration scheme is applied, the evaluation result may be weighted in accordance with a module. For example, to easily give a determination result indicating that a behavior is inhibited when there is a possibility of violation of the moral codes, the law, or the like, the weight of the evaluation result from the objective evaluation module 102 may be set to be heavy.

For example, to inhibit a behavior which is likely to be disadvantageous to the others, the weight of the evaluation result from the other's viewpoint behavior evaluation module 104 may be set to be heavy.

When a benefit of the self-system is prioritized, the weight of the evaluation result from the self-viewpoint behavior evaluation module 103 may be set to be heavy.

As a determination method of the determination unit 214, one or a combination of the foregoing AND scheme and the integration scheme may be used. For example, when the determination is performed in conformity with the AND scheme and it is determined that all of the evaluation results of the three modules satisfy the reference value, the determination may be further performed in conformity with the integration scheme.

As a determination method of the determination unit 214, the AND scheme and the integration scheme will be described as an example herein, but other determination schemes can also be applied.

The integrated evaluation module 105 is an application of a reinforced learning network and the evaluation results may be weighted so that a behavior and result recognition are fed back as a remuneration amount and are optimized.

The integrated evaluation module 105 can be configured as a module that determines whether an output of a candidate behavior is simply inhibited and also urges an output of a next best candidate behavior. For example, when a plurality of candidate behaviors are evaluated, the plurality of candidate behaviors may be output in a recommendation order. For example, when candidate behaviors considered to be evaluation targets are determined to be inhibited, other behaviors (next best behaviors) which are determined not to be inhibited may be output.

In the case of an evaluation system to which the present technology is not applied, an output is merely stopped. The evaluation system to which the present technology is applied can perform evaluation and output of subsequent candidate behaviors.

According to the foregoing embodiment, comprehensive determination can be performed in consideration of not only benefits of other systems, users, or the like in an environment but also codes (so-called common sense) in the environment rather than maximization of the self-benefit.

By having evaluation of the other systems or evaluation of the codes in the environment as each independent module, it is possible to perform optimum determination every time even for different models or others that have unknown models or different environments.

According to the present technology, as described above, the determination can be performed in consideration of others, moral codes, or the like. Therefore, the present technology is a considerably appropriate technology applied to a system in which sociality is necessary, such as a mobile robot coexisting with, for example, a plurality of robots or a system interacting with a user.

Accordingly, several specific examples to which the present technology can be applied will be described.

### Application Example 1

The present technology can be applied to an autonomous mobile robot. An autonomous mobile robot is, for example, a robot that determines a situation and behavior by itself.

By applying the present technology to coordinated control or behavior learning of autonomous mobile robots, for example, a coordinated behavior in which benefits of other robots and constraints of an environment are taken into consideration under an environment in which a plurality of mobile robots coexist is possible. Accordingly, it is possible to improve work efficiency in the plurality of robots.

When the present technology is applied to autonomous mobile robots, the self-viewpoint behavior evaluation module 103 selects an evaluation function appropriate under an environment and outputs a behavior maximizing a remuneration amount in the evaluation function.

The other's viewpoint behavior evaluation module 104 evaluates benefits or non-benefits of other robots that have observed known or unknown learned models. Evaluation target may include not only other assumed robots but also people or mobile objects manipulated by people.

The objective evaluation module 102 determines an optimum behavior in the environment, in particular, a local environment. The environment is, for example, a service environment to which a specific city or area or autonomous mobile robots are applied. Here, a service is, for example, a service or the like included in an automatic vehicle allocation system, a driving support system, a congestion monitoring system, or another mobility as a service (MaaS).

### Application Example 2

The present technology can be applied to a general interpersonal communication system.

As described above, the present technology can be applied to a conversation generation system such as a chatbot. When the present technology is applied to a system that generates conversations with a plurality of users, conversations in which states of conversation partners are taken into consideration can be generated. For example, it is possible to generate conversations in which insulting words or aggressive words are inhibited.

The present technology can be applied a game artificial intelligence (AI). During a game, there is a character called a non-player character (NPC). The present technology can be applied to determine a behavior of the NPC. In the game, there are the plurality of NPCs and players enjoying the game.

When a behavior of a predetermined NPC is determined among the plurality of NPCs, the present technology can be applied to recognize behaviors of the other NPCs or the players enjoying the game and set more natural behaviors or more effective behaviors.

When the present technology is applied to an interpersonal communication system, not only peoples in the systems but also unmanned systems, for example, AI robots or the like may be mixed. According to the present technology, even when people or systems other than people are mixed in an environment, optimum behaviors may be output to the people or the systems other than people. That is, according to the present technology, optimum behaviors including various environmental factors can be taken.

### Application Example 3

The present technology can be applied to an evaluation system for a user behavior. For example, by causing the information processing device 31 to which the present technology is applied to process a behavior performed by a user, it is possible to evaluate whether the behavior is appropriate.

When the present technology is applied to an evaluation system for a user behavior, the behavior definition unit 101 (see FIG. 4) defines an observed and recognized user behavior in a form which can be interpreted by the behavior evaluation module 44. The self-viewpoint behavior evaluation module 103 evaluates whether the user behavior is beneficial to the user.

The other's viewpoint behavior evaluation module 104 evaluates benefits/non-benefits for others related to the user behavior. The objective evaluation module 102 evaluates the user behavior using the evaluation system 135 (see FIG. 5) appropriate to be applied to the user behavior. The evaluation system 135 can uses an evaluation database such as a social credit system or a coaching system optimized by an application.

As the application when the present technology is applied to the evaluation system for a user behavior, the following applications can be considered.

An evaluation system that performs moral determination of a user behavior (a social credit system, a social credit score calculation system, or the like). An advisor system for a user behavior (a coaching system, an education system, or the like).

When the present technology is applied to the evaluation system, an evaluation target is not limited to people and may be other systems. Behaviors of the other systems can also be evaluated.

### Application Example 4

The present technology can be applied to a function of describing a self-behavior.

A system to which the present technology is applied can present a process of determining a self-behavior by using an output result of an output self-behavior from each of the objective evaluation module 102, the self-viewpoint behavior evaluation module 103, and the other's viewpoint behavior evaluation module 104.

Processing (a relation between an input candidate behavior and an output result) of each module can remain as a history and the history can be presented.

By presenting the history, for example, it is possible to prove that a processing target candidate behavior has not been performed due to violation of moral codes or a candidate behavior has not been performed due to a possibility of harming of other's benefits. The presented history may be various kinds of data described as the disclosure of the present technology such as an input and an output of each module, its weight, and a reference value of value determination.

At this time, when a plurality of candidate behaviors are performed a plurality of times until behavior determination, an intermediate output in each performance can also be presented. The presentation of a process can be given in a form which humans can understand. For example, presentation can be given using a speech or a label for a behavior purpose rather than a numerical value.

The application examples given herein are exemplary and are not limited to description. The present technology can be applied to application examples other than the foregoing application examples.

### <Hardware Configuration>

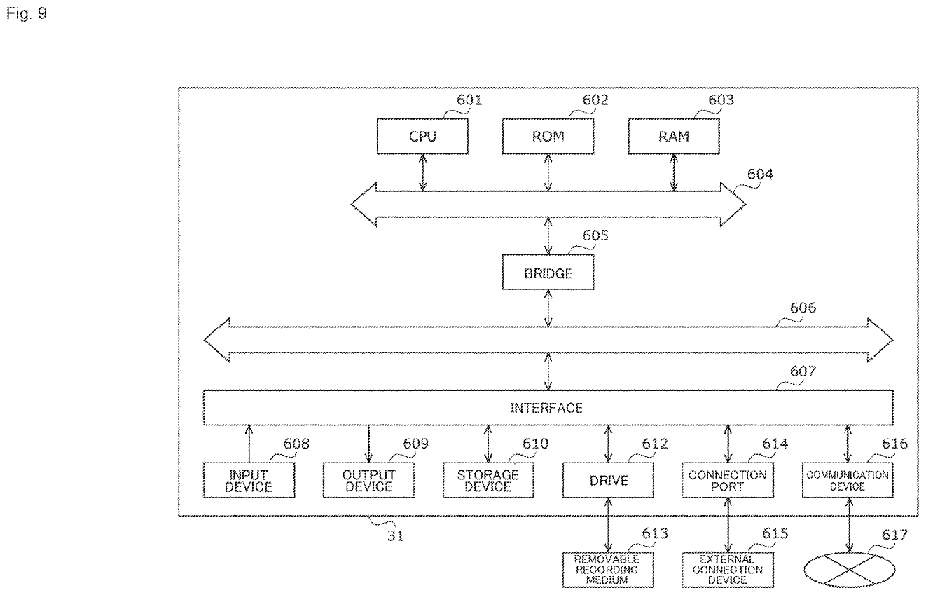

Next, an exemplary hardware configuration of the information processing device 31 according to an embodiment of the present disclosure will be described in detail with reference to FIG. 9. FIG. 9 is a functional block diagram illustrating an exemplary hardware configuration of the information processing device 31 according to an embodiment of the present disclosure.

The information processing device 31 according to the embodiment mainly includes a CPU 601, a ROM 602, and a RAM 603. The information processing device 31 further includes a host bus 604, a bridge 605, an external bus 606, an interface 607, an input device 608, an output device 609, a storage device 610, a drive 612, a connection port 614, and a communication device 616.

The CPU 601 functions as an arithmetic processing device and a control device and controls all or some of the operations in the information processing device 31 in accordance with various program recorded on the ROM 602, the RAM 603, the storage device 610, or a removable recording medium 613. The ROM 602 stores a program, an arithmetic parameter, and the like used by the CPU 601. The RAM 603 primarily stores a program used by the CPU 601 or a parameter or the like which is appropriately changed during execution of the program. These units are connected to each other by a host bus 604 configured by an internal bus such as a CPU bus.

The host bus 604 is connected to the external bus 606 such as a peripheral component interconnect/interface (PCI) bus via the bridge 605. The input device 608, the output device 609, the storage device 610, the drive 612, the connection port 614, and the communication device 616 are connected to the external bus 606 via the interface 607.

The input device 608 is, for example, manipulation means such as a mouse, a keyboard, a touch panel, a button, a switch, a lever, a pedal manipulated by a user. The input device 608 may be, for example, remote control means (a so-called remote controller) using infrared light or other radio waves or may be an external connection device 615 such as a mobile phone or a PDA corresponding to a manipulation of the information processing device 31. Further, the input device 608 is configured with an input control circuit or the like that generates an input signal based on information input by a user using the manipulation means and outputs the input signal to the CPU 601. A user of the information processing device 31 can input various kind of data or give an instruction for processing operation to the information processing device 31 by manipulating the input device 608.

The output device 609 is configured as a device that can notify the user of acquired information visually or auditorily. As the device, there is a display device such as a CRT display device, a liquid crystal display device, a plasma display device, an EL display device, and a lamp, sound output device such as a speaker and a headphone, or a printer device. The output device 609 outputs, for example results obtained through various kinds of processing performed by the information processing device 31. Specifically, the display device displays the results obtained through various kinds of processing performed by the information processing device 31 as text or images. On the other hand, the audio output device converts an audio signal formed from reproduced audio data, acoustic data, or the like into an analog signal and outputs the converted analog signal.

The storage device 610 is a data storage device configured as an example of a storage unit of the information processing device 31. The storage device 610 is configured with, for example, a magnetic storage device such as a hard disk drive (HDD), a semiconductor storage device, an optical storage device, or a magneto-optical storage device. The storage device 610 stores various kinds of data or a program executed by the CPU 601.

The drive 612 is a recording medium reader/writer and is contained or externally attached to the information processing device 31. The drive 612 reads information recorded on the mounted removable recording medium 613 such as a magnetic disk, an optical disc, a magneto-optical disc, or a semiconductor memory and outputs the information to the RAM 603. The drive 612 can also record information on the mounted removable recording medium 613 such as a magnetic disk, an optical disc, a magneto-optical disc, or a semiconductor memory. The removable recording medium 613 is, for example, a DVD media, an HD-DVD medium, or a Blu-ray (registered trademark) medium. The removable recording medium 613 may be a CompactFlash (registered trademark) (CF: CompactFlash), a flash memory, or a secure digital memory card (SD memory card). The removable recording medium 613 may be, for example, an electronic device or an integrated circuit (IC) card on which a contactless IC chip is mounted.

The connection port 614 is a port for directly connection to the information processing device 31. Examples of the connection port 614 include a universal serial bus (USB) port, an IEEE1394 port, and a small computer system interface (SCSI) port. Other examples of the connection port 614 include an RS-232C port, an optical audio terminal, and a high-definition multimedia interface (HDMI) (registered trademark) port. When the external connection device 615 is connected to the connection port 614, the information processing device 31 directly acquires various kinds of data from the external connection device 615 or supplies various kinds of data to the external connection device 615.

The communication device 616 is, for example, a communication interface configured with a communication device or the like for connection to a communication network (network) 917. The communication device 616 is, for example, a wired or wireless local area network (LAN) or a communication card for Bluetooth (registered trademark) or wireless USB (WUSB). The communication device 616 may be a router for optical communication, a router for asymmetric digital subscriber line (ADSL), or any of various communication modems. The communication device 616 can transmit and receive a signal or the like to and from the Internet or another communication device in conformity with, for example, a predetermined protocol such as TCP/IP. The communication network 617 connected to the communication device 616 may be configured with a network or the like connected in a wireless or wired manner and may be the Internet, a household LAN, or a network for infrared communication, radio wave communication, or satellite communication.

The exemplary hardware configuration capable of implementing functions of the information processing device 31 according to an embodiment of the present disclosure has been described above. Each of the constituent elements may be configured using a general-purpose member or may be configured using hardware specialized for the function of each constituent element. Accordingly, the hardware configuration to be used can be changed appropriately in accordance with a technical level when the embodiment is implemented.

A computer program for implementing each function of the information processing device 31 according to the above-described embodiment can be produced and mounted on a personal computer or the like. A computer-readable recording medium in which the computer program is stored can also be supplied. Examples of the recording medium include a magnetic disk, an optical disc, a magneto-optical disc, and a flash memory. The foregoing computer program may be delivered via, for example, a network without using a recording medium. The number of computers executing the computer program is not particularly limited. For example, the computer program may be executed by a plurality of computers (for example, a plurality of servers) in cooperation.

The program executed by a computer may be a program that performs processing chronologically in the order described in the present specification or may be a program that performs processing in parallel or at a necessary timing such as a called time.

In the present specification, the system is a general system configurated with the plurality of system.

The advantageous effects described in the present specification are merely exemplary and are not limited, and other advantageous effects may be achieved.

Embodiments of the present technology are not limited to the above-described embodiments and can be modified in various forms within the scope of the present technology without departing from the gist of the present technology.

The present technology can be configured as follows.

(1)
An information processing device including:
a first evaluation unit configured to evaluate a behavior from a self-viewpoint; a second evaluation unit configured to evaluate the behavior from an other's viewpoint; and
a determination unit configured to determine whether the behavior is performed from a first evaluation result in the first evaluation unit and a second evaluation result in the second evaluation unit.
(2)
The information processing device according to (1), further including: a third evaluation unit configured to evaluate the behavior from an objective viewpoint,
wherein the determination unit performs the determination using a third evaluation result in the third evaluation unit.
(3)
The information processing device according to (1) or (2), wherein the second evaluation unit converts the behavior into a behavior at the other's viewpoint and evaluates the converted behavior.
(4)
The information processing device according to any one of (1) to (3), wherein the behavior is a behavior performed as a candidate by the system or a behavior performed by the system.
(5)
The information processing device according to any one of (1) to (4), wherein the first and second evaluation units perform the evaluation using a learned model learned by reinforced learning.
(6)
The information processing device according to (5), wherein the first evaluation unit evaluates a remuneration amount predicted when a system controlled by the information processing device performs the behavior, and
wherein the second evaluation unit evaluates an influence of the behavior on other systems when the system controlled by the information processing device performs the behavior.
(7)
The information processing device according to (5) or (6), wherein the first and second evaluation units perform the evaluation using the same learned model.
(8)
The information processing device according to any one of (5) to (7), wherein the second evaluation unit performs the evaluation using the learned model learned from the other's viewpoint.
(9)
The information processing device according to any one of (2) to (8), wherein the third evaluation unit performs the evaluation with reference to a database related to a social norm.
(10)
The information processing device according to any one of (2) to (9), wherein the determination unit determines whether the behavior is suppressed using the first to third evaluation results.
(11)
The information processing device according to any one of (2) to (10), wherein the determination unit determines that the behavior is suppressed when at least two of the first to third evaluation results does not satisfy a standard value.
(12)
The information processing device according to any one of (2) to (11), wherein the determination unit performs statistics processing on the first to third evaluation results and determines whether the behavior is performed using a result of the statistics processing.
(13)
The information processing device according to any one of (1) to (12), wherein the first evaluation unit evaluates whether a behavior maximizes a remuneration amount in an autonomously moving robot, and
wherein the second evaluation unit evaluates a benefit or a non-benefit of the behavior of the robot to others.
(14)
The information processing device according to any one of (2) to (12), wherein the behavior is generation of a sentence which is presented to a user, and
wherein the third evaluation unit evaluates whether the sentence is inappropriate compared to a social norm.
(15)
The information processing device according to any one of (1) to (12), wherein the behavior is a behavior performed by a user,
wherein the first evaluation unit evaluates whether the behavior is beneficial to the user, and
wherein the second evaluation unit evaluates whether the behavior is beneficial to others influenced by the behavior performed by the user.
(16)
The information processing device according to any one of (1) to (12), wherein a process of determining the behavior is presented using the evaluation result of each of the first and second evaluation units.
(17)
An information processing method of causing an information processing device to perform:
evaluating a behavior from a self-viewpoint;
evaluating the behavior from an other's viewpoint; and
determining whether the behavior is performed from an evaluation result of the behavior from the self-viewpoint and an evaluation result of the behavior from the other's viewpoint.
(18)
A program causing a computer to perform processing including steps of: evaluating a behavior from a self-viewpoint;
evaluating the behavior from an other's viewpoint; and
determining whether the behavior is performed from an evaluation result of the behavior from the self-viewpoint and an evaluation result of the behavior from the other's viewpoint.

### REFERENCE SINGS LIST

11 Learned model
31, 32 Information processing device
41 Recognition unit
42 Candidate behavior generation unit
43 Control unit
44 Behavior evaluation module
71 Objective evaluation determination unit
72 Self-remuneration amount determination unit
73 Other's remuneration amount determination unit
74 Comparative evaluation determination unit
101 Behavior definition unit
102 Objective evaluation module
103 Self-viewpoint behavior evaluation module
104 Other's viewpoint behavior evaluation module
105 Integrated evaluation module
106 Behavior evaluation result output unit
131 Candidate behavior information input unit
132 State observation information input unit
133 Reference unit
134 Evaluation result output unit
135 Evaluation system
161 Candidate behavior information input unit
162 State observation information input unit
163 Learned model
164 Predicted remuneration amount output unit
191 Candidate behavior information input unit
192 State observation information input unit
193 Other's viewpoint candidate behavior information generation unit
194 Other's viewpoint state observation information generation unit
195 Learned model
196 Predicted remuneration amount output unit
211 Objective evaluation result input unit
212 Self-viewpoint behavior evaluation result input unit
213 Other's viewpoint behavior evaluation result input unit
214 Determination unit

1. An information processing device comprising:
a first evaluation unit configured to evaluate a behavior from a self-viewpoint;
a second evaluation unit configured to evaluate the behavior from another's viewpoint; and
a determination unit configured to determine whether the behavior is performed from a first evaluation result in the first evaluation unit and a second evaluation result in the second evaluation unit.

2. The information processing device according to claim 1, further comprising:
a third evaluation unit configured to evaluate the behavior from an objective viewpoint,
wherein the determination unit performs the determination using a third evaluation result in the third evaluation unit.

3. The information processing device according to claim 1, wherein the second evaluation unit converts the behavior into a behavior from the other's viewpoint and evaluates the converted behavior.

4. The information processing device according to claim 1, wherein the behavior is a behavior performed as a candidate by a system or a behavior performed by the system.

5. The information processing device according to claim 1, wherein the first and second evaluation units perform the evaluation using a learned model learned by reinforced learning.

6. The information processing device according to claim 5, wherein the first evaluation unit evaluates a remuneration amount predicted when a system controlled by the information processing device performs the behavior, and wherein the second evaluation unit evaluates an influence of the behavior on other systems when the system controlled by the information processing device performs the behavior.

7. The information processing device according to claim 5, wherein the first and second evaluation units perform the evaluation using the same learned model.

8. The information processing device according to claim 5, wherein the second evaluation unit performs the evaluation using the learned model learned from the other's viewpoint.

9. The information processing device according to claim 2, wherein the third evaluation unit performs the evaluation with reference to a database related to a social norm.

10. The information processing device according to claim 2, wherein the determination unit determines whether the behavior is suppressed using the first to third evaluation results.

11. The information processing device according to claim 2, wherein the determination unit determines that the behavior is suppressed when at least two of the first to third evaluation results do not satisfy a standard value.

12. The information processing device according to claim 2, wherein the determination unit performs statistics processing on the first to third evaluation results and determines whether the behavior is performed using a result of the statistics processing.

13. The information processing device according to claim 1, wherein the first evaluation unit evaluates whether a behavior maximizes a remuneration amount in an autonomously moving robot, and
wherein the second evaluation unit evaluates a benefit or a non-benefit of the behavior of the robot to others.

14. The information processing device according to claim 2, wherein the behavior is generation of a sentence which is presented to a user, and
wherein the third evaluation unit evaluates whether the sentence is inappropriate compared to a social norm.

15. The information processing device according to claim 1, wherein the behavior is a behavior performed by a user,
wherein the first evaluation unit evaluates whether the behavior is beneficial to the user, and
wherein the second evaluation unit evaluates whether the behavior is beneficial to others influenced by the behavior performed by the user.

16. The information processing device according to claim 1, wherein a process of determining the behavior is presented using the evaluation result of each of the first and second evaluation units.

17. An information processing method of causing an information processing device to perform:
evaluating a behavior from a self-viewpoint;
evaluating the behavior from another's viewpoint; and
determining whether the behavior is performed from an evaluation result of the behavior from the self-viewpoint and an evaluation result of the behavior from the other's viewpoint.

18. A program causing a computer to perform processing including steps of:
evaluating a behavior from a self-viewpoint;
evaluating the behavior from another's viewpoint; and
determining whether the behavior is performed from an evaluation result of the behavior from the self-viewpoint and an evaluation result of the behavior from the other's viewpoint.
